(19) United States
(12) Patent Application Publication
(10) Pub. No.: US 2006/0279880 A1
(43) Pub. Date: Dec. 14, 2006

(54) Suspension with sway beam micropositioning

(75) Inventors: Zine-Eddine Boutaghou, North Oaks, MN (US); Andrew D. White, Brooklyn Park, MN (US)

Correspondence Address: Derek J. Berger;Seagate Technology LLC, Intellectual Property - COL2LGL, 389 Disc Drive, Longmont, CO, 80503, US

(73) Assignee: Seagate Technology LLC

(21) Appl. No.: 11/147,537

(22) Filed: Jun. 8, 2005

(51) Int. Cl. G11B 5/48; G11B 21/16; G11B 5/56; G11B 21/24

(52) U.S. Cl. 360/294.4; 360/244.8

(57) ABSTRACT

An actuator suspension comprising a base supporting a load beam. The base defines a mount and a compliant sway portion. The compliant sway portion comprises a sway beam depending proximally from the mount and distally supporting the load beam. The suspension further comprises a piezoelectric element motor attached to the sway beam and adapted for bending the sway beam in a sway plane. A method is provided comprising: providing the actuator suspension with a base defining a compliant sway portion comprising a sway beam depending at one end from the base and supporting a load beam at an opposing end thereof; attaching one end of a piezoelectric element motor to the sway beam adjacent the mount and the other end also to the sway beam; energizing the piezoelectric element motor to impart the bending force to the sway beam in the sway plane.

### FIELD OF THE INVENTION

The claimed invention relates generally to the field of data storage device actuators and more particularly, but not by way of limitation, to an apparatus and method for trackwise micropositioning of the data transfer head.

### BACKGROUND

Data storage devices employ actuators to position data storing and retrieving heads with respect to data tracks of a data storage medium. The actuator can be positioned by a primary means, such as with a voice coil motor. The actuator can simultaneously be micropositioned by secondary means, such as with a piezoelectric element motor acting on a flexible suspension portion of the actuator. As storage densities have dramatically increased, so have the complexities in track following schemes to ensure reliable data transfer. Secondary actuation appears to be a promising avenue to resolving some of these complexities.

The actuator has a flexible suspension portion with a load beam imparting a biasing force on the head in opposition to the fluid bearing pushing the head away from the data storage medium. The load beam depends from a rigid mount portion that is connected, such as by a swage operation, to a rigid actuator arm.

Some solutions attempt to apply the secondary actuation to a gimbal supporting the head. Other solutions attempt to apply the secondary actuation to the load beam, at either a preload bend section thereof or at a portion between the bend section and the attached gimbal. In either event, the goal of building in an active suspension mechanism to the load beam or gimbal runs counter to the need for structural integrity sufficient to keep the resonant frequencies high enough to prevent resonant disturbances from adversely affecting data transfer reliability. These active suspension mechanisms also require complicated and delicate structure that is expensive to make and assemble. The previously attempted solutions also require routing the flex circuit off the load beam longitudinal centerline, resulting in windage penalties for the actuator in seeking and tracking performance. What is needed is a solution that employs a simple and inexpensive compliant sway mode mechanism that also permits center-routing of the flex circuit. It is to these improvement features that the embodiments of the present invention are directed.

### SUMMARY OF THE INVENTION

Embodiments of the present invention are generally directed to an actuator suspension.

In some embodiments an actuator suspension is provided comprising a base supporting a load beam. The base defines a mount and a compliant sway portion. The compliant sway portion comprises a sway beam depending proximally from the mount and distally supporting the load beam. The suspension further comprises a piezoelectric element motor connected to the sway beam and adapted for bending the sway beam in a sway plane.

In some embodiments a method is provided comprising: providing the actuator suspension with a base defining a compliant sway portion comprising a sway beam depending at one end from the base and supporting a load beam at an opposing end thereof; connecting one end of a piezoelectric element motor adjacent the mount and the other end to the sway beam; energizing the piezoelectric element motor to impart a bending force to the sway beam in a sway plane.

In some embodiments a data storage device is provided comprising an actuator in combination with a data storage medium, and means for positioning the actuator in an operable data storing and data retrieving relationship with the data storage medium. The means for positioning is characterized by selectively bending a compliant sway portion of the actuator in a sway plane.

These and various other features and advantages which characterize the claimed invention will become apparent upon reading the following detailed description and upon reviewing the associated drawings.

### BRIEF DESCRIPTION OF THE DRAWINGS

FIG. 1 is a plan view of a data storage device constructed in accordance with embodiments of the present invention.

FIG. 2 is an isometric view of the suspension assembly of FIG. 1.

FIG. 3 is an enlarged plan view of a portion of the suspension assembly of FIG. 2.

FIG. 4 is an enlarged plan view of a portion of a suspension assembly constructed in accordance with alternative embodiments of the present invention.

FIG. 5 is an enlarged plan view of the suspension assembly of FIG. 3 but modified in accordance with embodiments of the present invention.

FIG. 6 is an enlarged plan view of a portion of a suspension assembly constructed in accordance with alternative embodiments of the present invention.

FIG. 7 is an enlarged plan view of a portion of a suspension assembly constructed in accordance with alternative embodiments of the present invention.

FIG. 8 is a diagrammatic view of the piezoelectric element motor of the embodiments of the present invention and in a parallel electrical arrangement.

FIG. 9 is a diagrammatic view of the piezoelectric element motor of FIG. 8 after energizing it.

FIG. 10 is a diagrammatic view of the piezoelectric element motor of the embodiments of the present invention and in a serial electrical arrangement.

FIG. 11 is a diagrammatic view of the piezoelectric element motor of FIG. 10 after energizing it.

FIG. 12 is a flowchart illustrating steps for practicing a method for sway microactuation in accordance with embodiments of the present invention.

### DETAILED DESCRIPTION

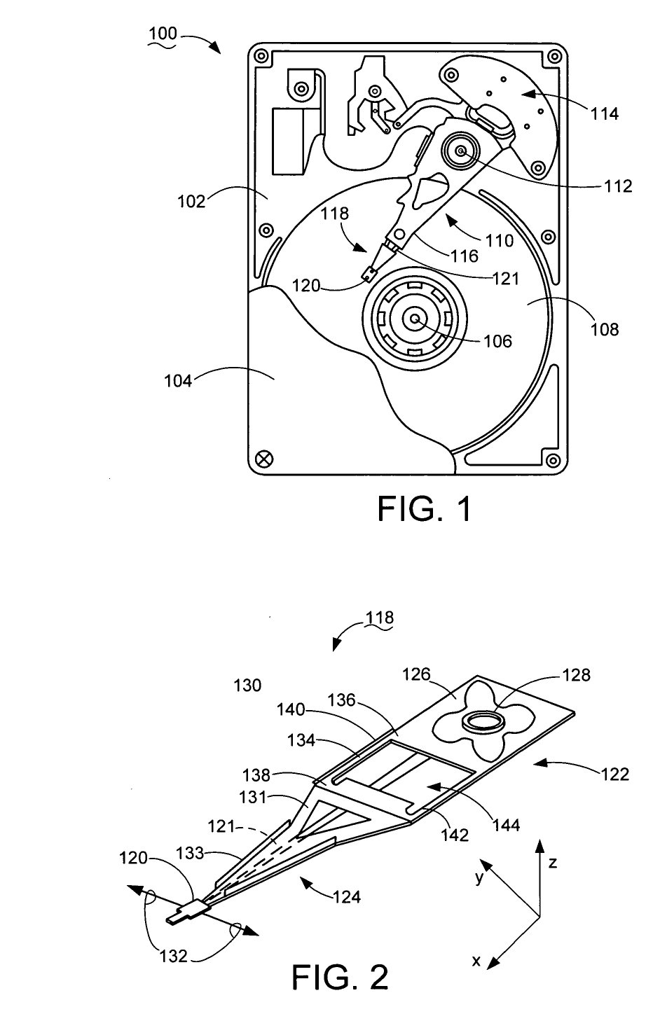

Turning to the drawings as a whole and particularly now to FIG. 1 which is a plan view of a data storage device 100 constructed in accordance with embodiments of the present invention. The data storage device 100 has a base 102 to which a cover 104 (partially cutaway) is attached with a sealing member therebetween to establish a sealed enclosure.

A spindle motor 106 is mounted to the base 102 for rotating one or more data storage mediums (“discs”) 108. An actuator, such as a rotary actuator 110, has a central body (or “eblock”) supported by the base 102 around a bearing 112 and pivotally moved by a voice coil motor 114. The actuator 110 has one or more rigid arms 116 extending from the body and supporting a proximal end of a flexible suspension assembly 118. The distal end of the suspension assembly 118 supports a head 120 having data storing and retrieving elements, as well as a slider assembly for flying the head 120 on a fluid bearing created by spinning the discs 108. A flexible circuit 121 transmits electrical signals to and from the head 120.

FIG. 2 is an isometric view of a suspension assembly 118 that is constructed in accordance with embodiments of the present invention. The suspension assembly 118 generally has a base portion 122 and a load beam portion 124. The base 122 defines a mount 126 for attachment to the actuator arm 116, such as by swaging a boss 128 within a receptacle formed by the arm 116 (not shown). In alternative equivalent embodiments the base 122 can be directly attached to the arm 116 without the boss 128, such as by fusing or adhesion. The base 122 also defines a compliant sway portion 130 for selectively moving the load beam 124, and in turn the head 120, laterally within a sway plane designated by arrows 132 in rotation around the z-axis. The load beam 124 generally has a reduced-thickness preload bend section 131 that defines a vertical stiffness resisting rotation around the y axis. A relatively greater thickness, or else stiffening flanges 133, provide additional torsional stiffness resisting rotation around the x-axis.

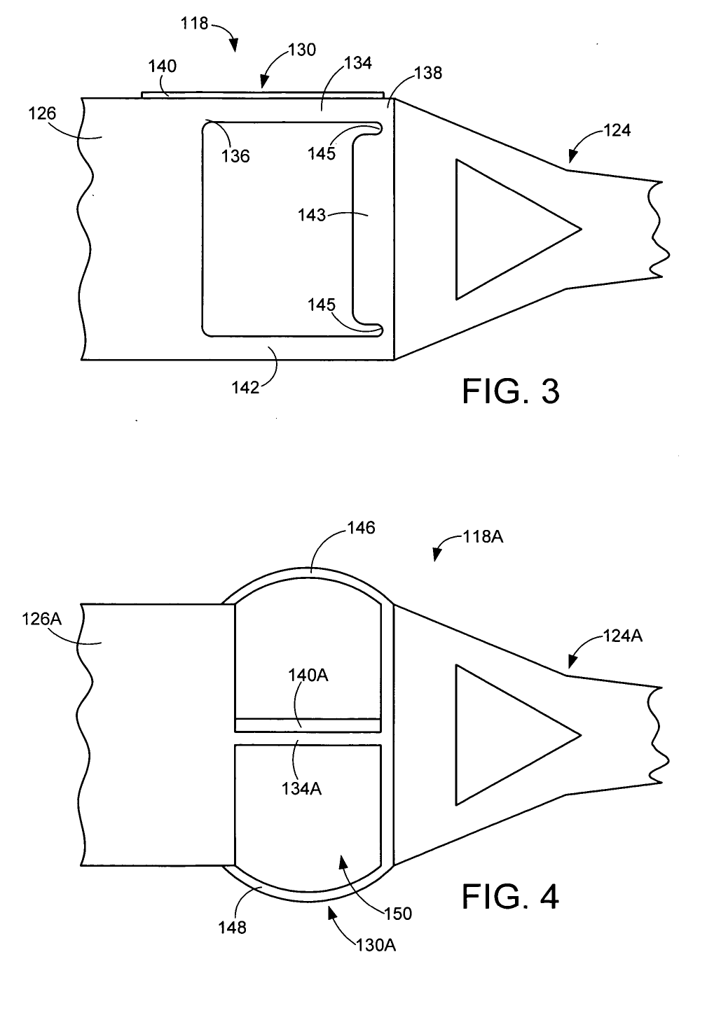

FIG. 3 is an enlarged detail plan view of the suspension assembly 118 of FIG. 2. The compliant sway portion 130 generally has a sway beam 134 depending at a proximal end 136 from the mount 126. A distal end 138 of the sway beam 134 supports the load beam 124. A piezoelectric element motor 140 is connected to the sway beam 134 and adapted for bending the sway beam 134 in the sway plane 132 (FIG. 2). It will be noted that the embodiments of FIGS. 2 and 3 contemplate a pair of sway beams 134, 142 that cooperate with the load beam 124 and the mount 126 in defining a substantially rectangular cavity 144 in the mount 126. Preferably, the sway beams 134, 142 and the load beam 124 are unitarily constructed, such as can be provided by etching, for example chemical or laser etching, the assembly from a solid sheet of material.

It will be noted that a flange member 143 can be provided to connect the sway beams 134, 142 together, and to connect the sway beams 134, 142 to the load beam 124. To reduce the lateral stiffiess of the flange 143, a thickness-reducing feature, such as an arcuate notch 145, can be defined by the flange 143 adjacent its intersection with the sway beams 134, 142.

Returning momentarily to FIG. 2, advantageously the compliant sway portion 130 structure does not interfere with a routing of the flexible circuit 121 in coaxial alignment with a longitudinal centerline of the load beam 124. This center-routing improves windage performance of the suspension assembly 118.

The rectangular compliant sway portion 130 of FIGS. 2 and 3 is illustrative and not enumerative or otherwise limiting of the embodiments of the present invention. For example, FIG. 4 is an enlarged detail plan view of a suspension assembly 118A that is constructed in accordance with alternative embodiments of the present invention. The suspension assembly 118A has a compliant sway portion 130A having a pair of opposing arcuate stabilizing members 146, 148 cooperating with the load beam 124A and the mount 126A in defining a substantially oval cavity 150 in the base 126A. A sway beam 134A intersects the cavity 150, preferably bisecting it to evenly distribute the load on the stabilizing members 146, 148. A piezoelectric element motor 140A is attached to the sway beam 134A for selectively bending the sway beam 134A in the sway plane 132 (FIG. 2). Preferably, the stabilizing members 146, 148, the sway beam 134A, and the load beam 124A are unitarily constructed, such as can be provided by laser etching the assembly from a solid sheet of material.

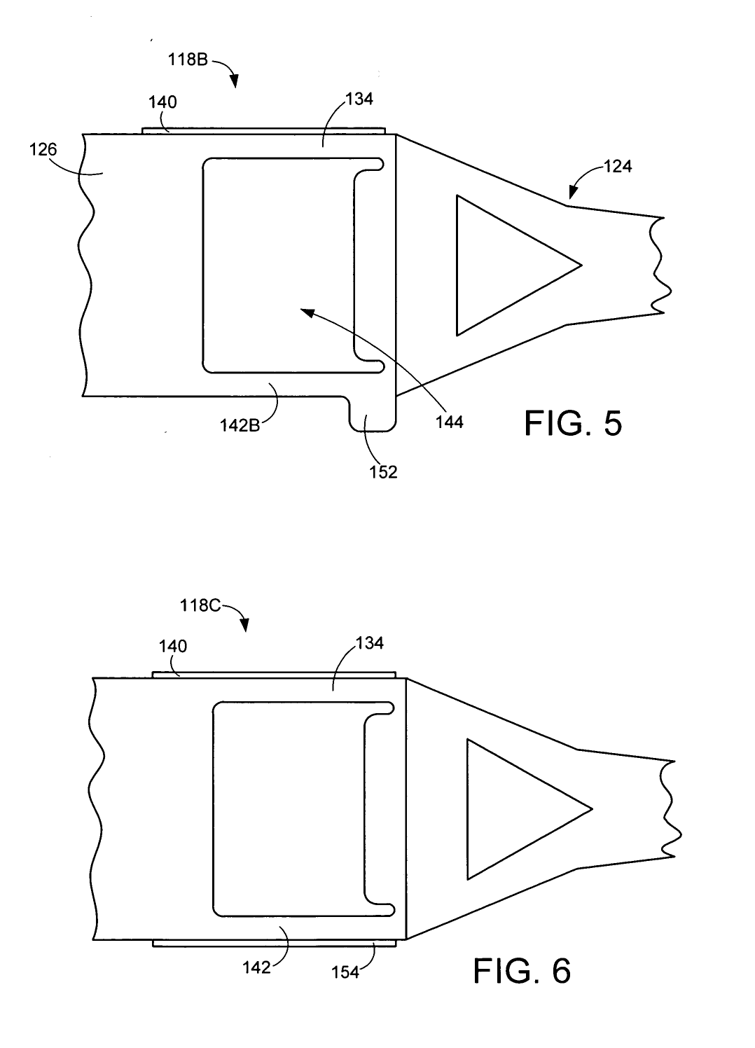

FIG. 5 illustrates embodiments of a suspension assembly 118B wherein a balancing mass 152 modifies the sway beam 142B so as to offset the weight of the piezoelectric element motor 140 attached to the opposing sway beam 134. The balancing mass 152 is preferably configured so as to not increase the bending stiffness of the sway beam 142B, such as would occur if the sway beam 142B were made wider to balance the actuator.

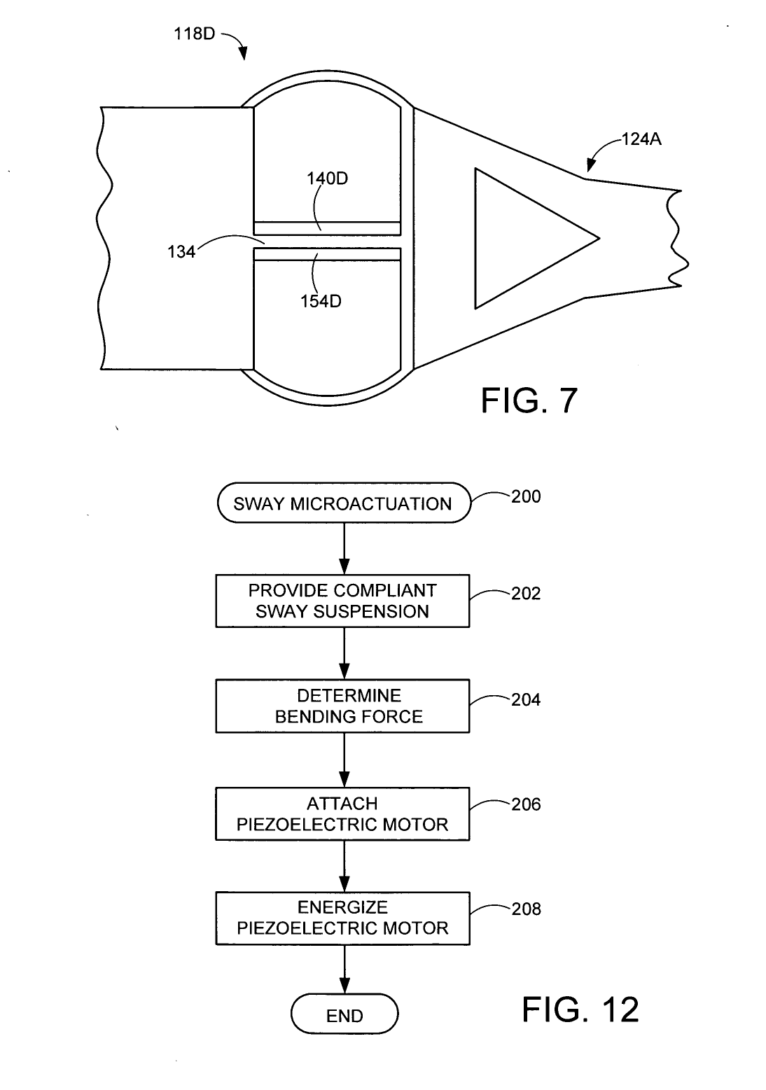

FIG. 6 illustrates embodiments of a suspension assembly 118C wherein a second piezoelectric element motor 154 is connected to the sway beam 142. Similarly, FIG. 7 illustrates embodiments of a suspension assembly 118D wherein the piezoelectric element motors 140D, 154D are connected to opposing sides of the sway beam 134.

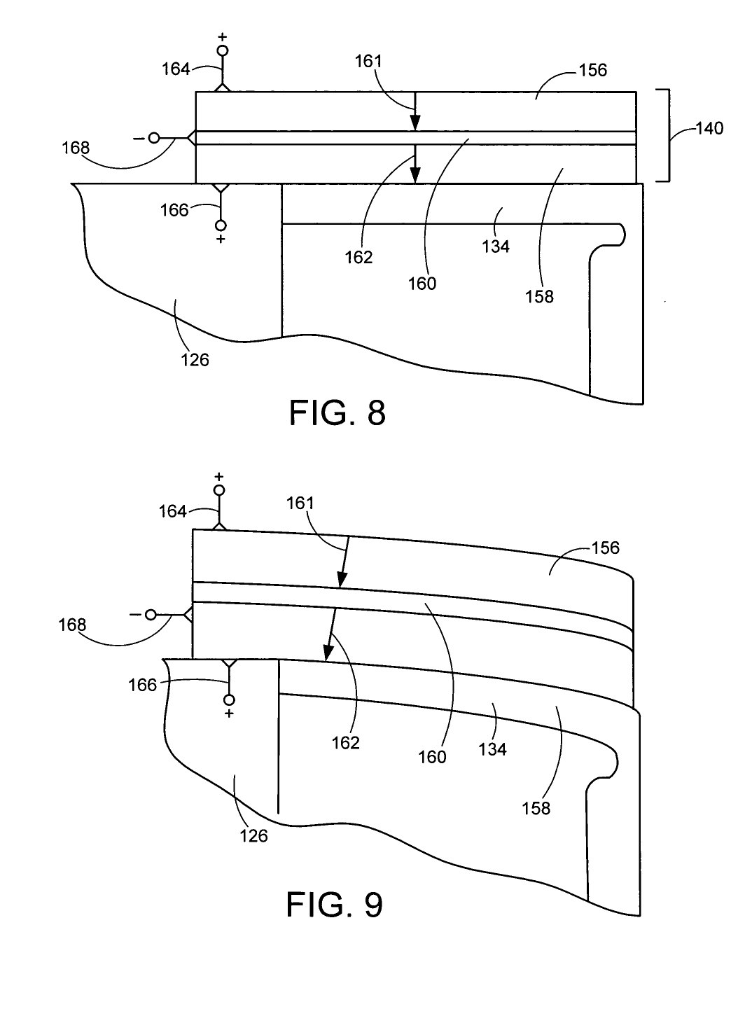

In any event, the piezoelectric element motor 140 imparts a bending force to the sway beam it is connected to in order to deflect the load beam 124 in the sway plane 132. Preferably, the piezoelectric element motor 140 comprises a bimorph actuator as illustrated in the embodiments of FIG. 8. The bimorph actuator has a first piezoelectric layer 156, a second piezoelectric layer 158, and a center conductive layer 160.

In the embodiments of FIG. 8, the poles of the layers 156, 158 are aligned as denoted by arrows 161, 162 in a parallel configuration. A first voltage is applied to the layers 156, 158 at the terminals 164, 166, respectively. A second voltage is applied to the conductive layer 160 at terminal 168. In this electrical arrangement, the layer 156 will expand and the layer 158 will contract when electrically energized. The result is a bending motion of the piezoelectric element motor 140, thereby imparting a bending force on the sway beam 134. The amount of bending force is related to the voltages applied to the terminals 164, 166, 168. FIG. 9 illustrates embodiments wherein the bending force is sufficient to deflect the sway beam 134 laterally, or within the sway plane 132.

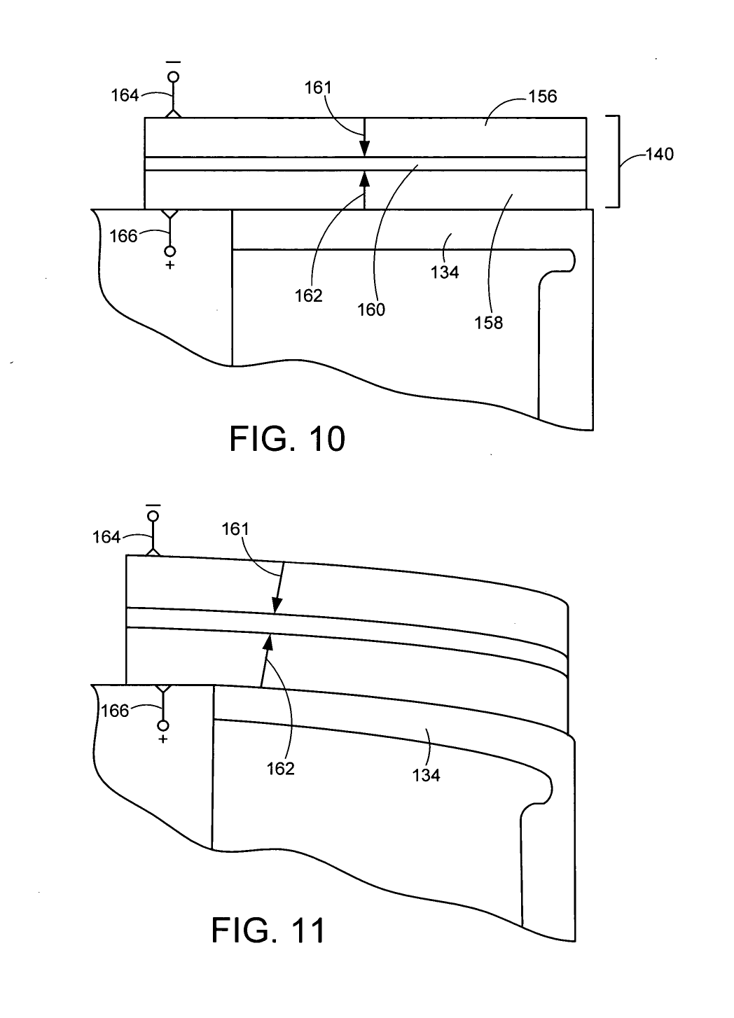

FIGS. 10 and 11 illustrate embodiments similar to FIGS. 8 and 9 except that the layers 156, 158 are electrically arranged serially. This arrangement offers relative simplicity, but at the price of reduced bending force. The poles of the layers 156, 158 are opposed as denoted by arrows 161, 162 in a serial configuration. A first voltage is applied at terminal 164 to layer 156, and a second voltage is applied at terminal 166 to layer 158. The result is a bending motion of the piezoelectric element motor 140, thereby imparting the bending force to the sway beam 134. This is a simpler electrical arrangement because the conductive layer 160 does not receive an applied voltage. However, the serial arrangement of FIGS. 10 and 11 yields a smaller deflection per volt of applied potential in comparison to the parallel arrangement of FIGS. 8 and 9.

It will be noted in the embodiments discussed that the sway beams 134, 142 form linear members, permitting the piezoelectric element motors to be connected thereto contiguously between a portion thereof adjacent the base 126 and the distal end.

FIG. 12 is a flowchart illustrating steps for practicing a method 200 for performing sway microactuation in accordance with embodiments of the present invention. The method 200 begins in block 202 with providing an actuator suspension constructed in accordance with embodiments of the present invention, having a base defining a compliant sway portion comprising a sway beam depending at one end from the base and supporting a load beam at an opposing end thereof. The method continues in block 204 with determining the bending force required to achieve the desired deflection of the load beam. The desired bending force determines the number of piezoelectric element motors needed, as well as the supply voltages to them. In block 206 the determined number of piezoelectric element motors are attached to the sway beams in the compliant sway portion. In block 208 the determined voltage is supplied to the piezoelectric element motor to impart a bending force to the sway beam in the sway plane. Preferably, where two or more piezoelectric element motors are employed, they are energized simultaneously.

Generally, embodiments of the present invention contemplate an actuator suspension (such as 118) comprising a base (such as 122) supporting a load beam (such as 124). The base defines a mount (such as 126) and a compliant sway portion (such as 130). The compliant sway portion comprises a sway beam (such as 134) depending proximally from the mount and distally supporting the load beam. The suspension further comprises a piezoelectric element motor (such as 140) connected to the sway beam and adapted for bending the sway beam in a sway plane (such as 132). Preferably, the piezoelectric element motor comprises a bimorph actuator that is contiguously connected to the sway beam between a first portion adjacent the base and a distal end of the bimorph actuator.

The compliant sway portion can comprise a pair of sway beams (such as 134, 142) that cooperate with the load beam and the mount in defining a substantially rectangular cavity (such as 144) in the base. In some embodiments the suspension includes a piezoelectric element motor on each of the sway beams. Alternatively, the compliant sway portion can define characteristically different cavities, such as a pair of opposing arcuate stabilizing members (such as 146, 148) cooperating with the load beam and the mount in defining a substantially oval cavity (such as 150) in the base with the sway beam intersecting, and preferably bisecting, the cavity.

A flange member (such as 143) can connect the sway beams to the load beam. The flange member can define a thickness reducing feature to reduce the bending force necessary to deflect the compliant sway portion. In some embodiments the thickness reducing feature can be an arcuate notch (such as 145) at the intersection of the sway beam or sway beams with the flange member.

Preferably, for simplicity of construction and cost sake, the compliant sway portion, including the sway beam or sway beams, and the load beam are unitarily constructed. Also, preferably a flex circuit is routed across the compliant sway portion in coaxial alignment with a longitudinal centerline of the load beam.

Furthermore, a method (such as 202) is contemplated comprising providing an actuator suspension constructed in accordance with embodiments of the present invention (such as 202), with a base defining a compliant sway portion comprising a sway beam depending at one end from the base and supporting a load beam at an opposing end thereof. The method includes determining the bending force required (such as 204), which is deterministic of the number of piezoelectric element motors required and the supply voltages thereto. The method further comprises attaching one end of a piezoelectric element motor to the sway beam adjacent the mount, and attaching the other end of the piezoelectric element motor to the sway beam (such as 206). The method further comprises energizing the piezoelectric element motor to impart a bending force to the sway beam in a sway plane (such as 208).

The providing step can be characterized by a compliant sway portion with two sway beams, such that the attaching step can be characterized by attaching two piezoelectric element motors, respectively. Preferably, the attaching step is characterized by electrically poling and engergizing the piezoelectric motors to bend them in the same direction. The providing step can be characterized by unitarily constructing the sway beam and the load beam. Preferably, the providing step is characterized by the piezoelectric element motor comprising a bimorph actuator.

A data storage device is contemplated, comprising an actuator in combination with a data storage medium, and means for positioning the actuator in an operable data storing and data retrieving relationship with the data storage medium. The means for positioning can be characterized by selectively bending a beam in a compliant sway portion of the actuator in a sway plane.

For purposes of this description and the appended claims, the claim term “means for positioning” expressly does not include previously attempted solutions that employ a piezoelectric element motor connected at one end thereof to the base and the other end thereof to the load beam, and which are thereby electrically energized to transfer longitudinal displacement of the piezoelectric element motors to lateral displacement of the load beam.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed. For example, the particular elements may vary depending on the particular processing environment without departing from the spirit and scope of the present invention.

In addition, although the embodiments described herein are directed to a data storage system, it will be appreciated by those skilled in the art that the claimed subject matter is not so limited and various other processing systems can utilize the embodiments of the present invention without departing from the spirit and scope of the claimed invention.

What is claimed is:

1. An actuator suspension comprising a base supporting a load beam, the base defining a mount and a compliant sway portion, the compliant sway portion comprising a sway beam depending proximally from the mount and distally supporting the load beam, the suspension further comprising a piezoelectric element motor connected to the sway beam and adapted for bending the sway beam in a sway plane.

2. The suspension of claim 1 wherein the compliant sway portion comprises a pair of sway beams that cooperate with the load beam and the mount in defining a substantially rectangular cavity in the base.

3. The suspension of claim 2 comprising a piezoelectric element motor on each of the sway beams.

4. The suspension of claim 3 wherein the piezoelectric element motors are electrically adapted such that energizing them simultaneously bends them in the same direction.

5. The suspension of claim 1 wherein the suspension comprises a flange member connecting the sway beam to the load beam, the flange defining a thickness reducing feature adjacent an intersection of the flange and the sway beam.

6. The suspension of claim 5 wherein the thickness reducing feature defines an arcuate surface.

7. The suspension of claim 2 wherein the sway beams and the load beam are unitarily constructed.

8. The suspension of claim 1 wherein the compliant portion comprises a pair of opposing arcuate stabilizing members cooperating with the load beam and the mount in defining a substantially oval cavity in the base with the sway beam intersecting the cavity.

9. The suspension of claim 8 wherein the sway beam bisects the cavity.

10. The suspension of claim 8 wherein the stabilizing members, the sway beam, and the load beam are unitarily constructed.

11. The suspension of claim 1 further comprising a flexible circuit spanning from the mount to a head supported by a distal end of the load beam, the flexible circuit routed across the compliant sway portion in coaxial alignment with a longitudinal centerline of the load beam.

12. The suspension of claim 1 wherein the piezoelectric element motor comprises a bimorph actuator.

13. The suspension of claim 1 wherein the piezoelectric element motor is contiguously connected to the sway beam between a first portion adjacent the base and a distal end of the piezoelectric element motor.

14. A method comprising:
providing an actuator suspension with a base defining a compliant sway portion comprising a sway beam depending at one end from the base and supporting a load beam at an opposing end thereof;
attaching one end of a piezoelectric element motor to the sway beam adjacent the mount and the other end also to the sway beam;
energizing the piezoelectric element motor to impart a bending force to the sway beam in a sway plane.

15. The method of claim 14 wherein the providing step is characterized by a compliant sway portion with two sway beams and the attaching step is characterized by attaching two piezoelectric element motors respectively.

16. The method of claim 15 wherein the providing step is characterized by electrically poling and connecting the piezoelectric motors to bend them in the same direction.

17. The method of claim 15 wherein the providing step is characterized by unitarily constructing the sway beam and the load beam.

18. The method of claim 15 wherein the providing step is characterized by the piezoelectric element motor comprising a bimorph actuator.

19. A data storage device comprising:
an actuator in combination with a data storage medium; and
means for positioning the actuator in an operable data storing and data retrieving relationship with the data storage medium.

20. The device of claim 19 wherein the means for positioning is characterized by selectively bending a compliant sway portion of the actuator in a sway plane.
